(19) United States
(12) Patent Application Publication
(10) Pub. No.: US 2003/0137847 A1
(43) Pub. Date: Jul. 24, 2003

(54) Portable telescoping light stand

(76) Inventor: Roston Cooper, Wilmington, IL (US)

Correspondence Address: Edward D. Gilhooly, MYERS & ASSOCIATES, LTD., 28 E. Jackson Blvd., Suite 423, Chicago, IL, 60604, US

(21) Appl. No.: 10/052,883

(22) Filed: Jan. 23, 2002

(51) Int. Cl. F21V 19/02

(52) U.S. Cl. 362/418; 362/427; 362/431

(57) ABSTRACT

A portable telescoping light stand including a vertical conduit having a vertical extension being moveable within the conduit. A horizontal arm is affixed to an upper end of the extension and a pair of DC light sources are carried by the horizontal arm. A plurality of pairs of holes are provided in the conduit to adjust the height of the extension in conjunction with a pair of holes provided at a lower position of said extension whereby a pin is inserted to established a height of the light stand. A pony clamp assembly is used to clamp the light to a support structure.

### BACKGROUND OF THE INVENTION

1. Field of the Invention

This invention relates to illuminating devices and more particularly, to a portable telescoping light stand capable of being attachably mounted on numerous vehicles and other support structures.

2. Summary of the Prior Art

It is frequently desirable to provide temporary or permanent illumination of work areas, recreation sites, social gatherings, and the like. In the past numerous light systems have been developed to provide needed illuminations in darkened areas. Some known light devices provide attachment elements to temporarily affix a light to vehicle or other structure. Prior art designs of such lights fail to provide needed versatility to attach a light assembly to a wide range of vehicles and other structures and provide suitable lighting under encountered conditions. Many light posts must be attached to bolt holes and the like that must be provided on a vehicle. The need for such intrusive attachment elements is inconvenient and undesirable. Further, many prior illuminating devices are not readily portable to provide ease of use and storage. It is therefore desirable in the industry to provide a portable light stand capable of versatility of use and economy of design.

### SUMMARY OF THE INVENTION

It is therefore an objective of the invention to provide a portable light stand for use under outdoor and indoor conditions for a high level of illumination. The light stand is economical to manufacture and use, and is telescopic in design to readily adjust the height of the illuminating devices. The invention is provided with a clamping means by which the light stand can easily be attached to numerous structures, including a truck, tractor, boat, automobile, fence, and other structure. The light stand herein can be stored easily in a vehicle to be transported anywhere. It can be used for vehicle repair, any work area, and illuminating recreational areas, such as camp grounds, basketball courts, and social gatherings. It also can be employed to illuminate home repairs, roadside emergencies, and farm work among countless applications in which light is needed. The direction of illumination of the light stand of the invention can readily be adjusted to meet varying conditions.

### BRIEF DESCRIPTION OF THE DRAWINGS

FIG. 1 is a front elevational view of the portable telescoping light stand of the invention;

FIG. 2 is side elevational view of the portable telescoping light stand of FIG. 1;

FIG. 3 is a partial side elevational view of FIG. 1 showing the support changes; and

FIG. 4 is a top plan view of the portable telescoping light stand of FIG. 1.

### DESCRIPTION OF THE PREFERRED EMBODIMENT

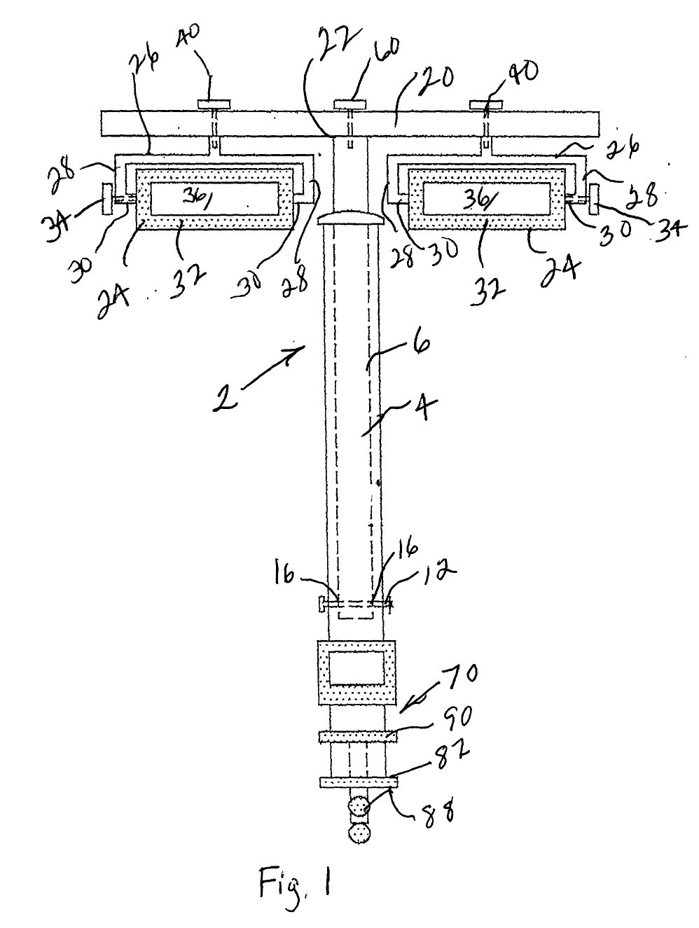

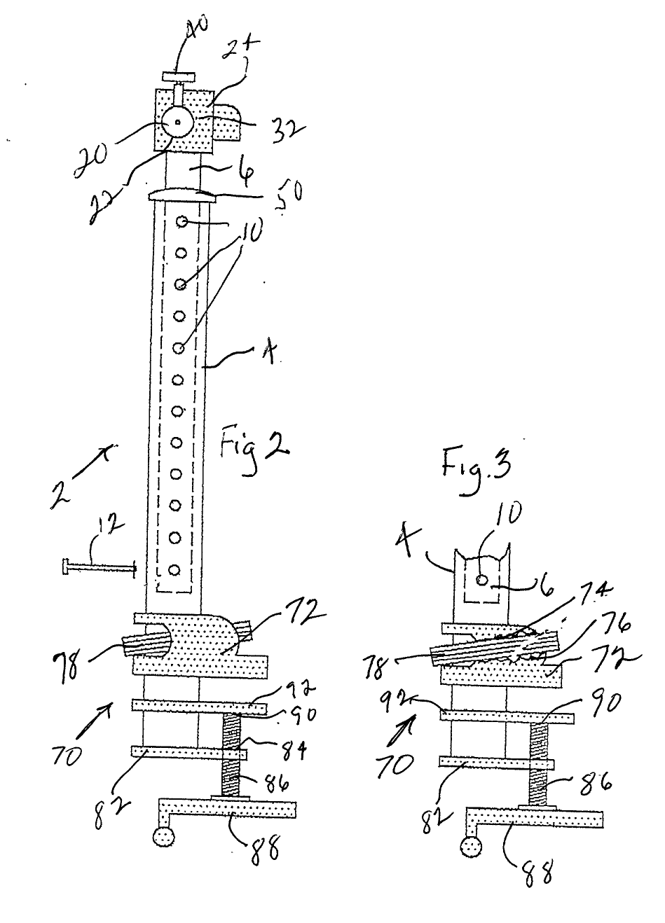

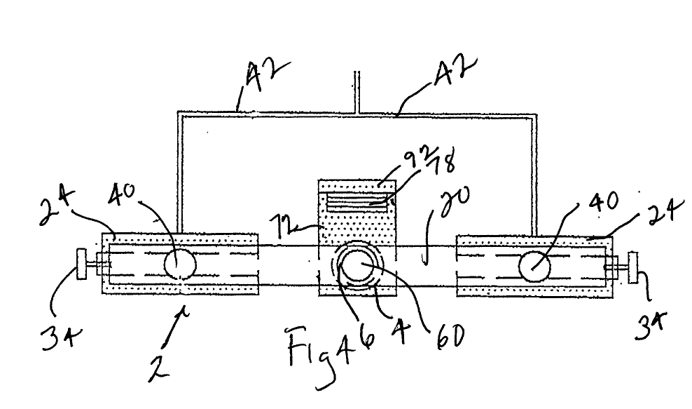

Referring now to FIGS. 1-4, there is illustrated the portable telescoping light stand of the invention, generally designated by reference numeral 2. The light stand 2 is formed by a outer vertical hollow conduit 4 having a telescopically mounted inner extension 6 disposed for movement within the conduit 4 to adjust the height of stand 2. The conduit 4 includes a plurality of pairs of opposed holes 10 through each side (one side shown in FIG. 2) to receive a cotter pin 12 or nut and bolt (not shown) at selected aligned holes 10. In addition, a pair of aligned holes 16 (FIGS. 1 and 2), which are capable of being aligned with a selected pair of holes 10 to select a position of extension 6 with respect to conduit 4 is formed at the bottom of extension 6. An example of one selected positioning of cotter pin 12 for a given height is shown in FIG. 1. Upon removal of cotter pin, the extension 6 can be moved relative to conduit 4 until another selected height of the light stand 2 can be achieved whereby the cotter pin 12 can be inserted through other aligned holes 10 of conduit 4 and the bottom hole of extension 6 for manually altering the height of the light stand 2. Alternatively, opposite spring-loaded buttons (not shown) can be externally attached to a bottom portion of extension 6. The spring loaded buttons expand into attachment to a selected hole 10 when in alignment and be compressed for removal from a pair of holes 10. As a further alternative to the invention, an elongated threaded shaft (not shown) may extend downward into extension 6 and an end portion engages a threaded hole in a member (not shown) fixedly attached to the extension 6 whereby rotation of the threaded shaft at a position above the conduit 4 and extension 6 controls their relative positioning.

A horizontal member 20 is suitably affixed at its midpoint by a conventional technique to the top end portion 22 of extension 6. A pair of light fixtures 24 having a modified U-shaped frame comprising base 26 and a pair of downwardly extending legs 28 are affixed to the underside of horizontal member 20. A pair of projections 30 extend inward from legs 28 to engage a conventional light source 32 for support. Thumb screws 34 extend through the outer legs 28 to facilitate securement and removal of the light assemblies 32 and allow rotational movement of the light fixtures when loosened. The light source 32 may have rectangular shaped lens 36 covering a DC light source, although it is within the scope of the invention to use a AC light source or a lens having other shapes, if suitable under encountered conditions. The light fixture frames 24 are secured to tube 20 by thumb screws 40 which allow the light fixture frame 30 to be tightened for position retention or loosened to allow pivotal movement of the light source for altering the direction of the light beam from lens 36. As seen in FIGS. 2 and 4, electrical cables 42 are electrically coupled to light sources 32 having plus and minus wires and can be attached to a source of DC electrical potential, such a 12 volt battery of a vehicle, a separate battery, or to a cigarette lighter as the power point connection. A pair of clamps (not shown) or cigarette adaptors (not shown) may be electrically connected to the plus and minus wires.

A cap 50 is attached to the top of conduit 4 and includes a central hole 52 to aid in guiding movement of the extension 6 in conduit 4. The extension 6 may be formed with a projecting bushing (not shown) to aid in guiding and supporting the extension 6 in conduit 4. A thumb screw 60 extends through the midpoint of the horizontal arm into a cap (not shown) mounted on the top of tube 6 and allows the horizontal arm to be tightened in position or loosened for rotation of the arm.

The light stand 2 is attached to any structure, such as a bumper, of a vehicle, a truck bed, boat, and fence but means of bar clamp assembly 70 in the form of conventional pony clamp as commercially available. The bar clamp 70 includes a upper housing 72 affixed to a lower portion of conduit 4. The housing 72 contain an upper clutch plate surface 74 and a lower clutch plate surface 76 having a plurality of clutch plates 78 disposed therebetween in contact with clutch surfaces 74 and 76. The bar clamp assembly 70 includes a lower plate 82 affixed to the end of conduit 4 and includes a threaded hole 84. A threaded shaft 86 extends through threaded hole 84 and is provided with an affixed hand crank 88. The upper end 90 of the threaded shaft 86 is rotatably affixed to a clamp plate 92 that is moveable along conduit 4. Rotation of hand crank 88 causes clamp plate 92 to move toward or away from the upper clamp surface 94 to clamp the light stand 2 to a support structure or to release the light stand. The use of conventional pony clamp 70 provides great versatility of use on the light stand 2 for clamping the invention to a wide range of different structures with need of intrusive modifications, such as holes, attachment elements and the like.

What is claimed is:

1. A portable telescoping light stand for attachment to a support structure comprising;
an outer vertical conduit, a vertical extension mounted telescopically within said vertical conduit and having an upper end,
a horizontal arm affixed to said upper end of said vertical extension,
said horizontal arm having a means for illuminating an area,
said vertical extension being moveable within said vertical conduit for varying the height of said means for illuminating area,
means for securing said vertical extension to said conduit at a plurality of positions for varying the height of said means for illuminating an area, and
a pony clamp attached to a lower of portion said vertical conduit for securing said vertical conduit to a support structure.

2. The portable telescoping light stand according to claim 1 wherein said horizontal arm is rotatably mounted on said conduit on a vertical axis.

3. The portable telescoping light stand according to claim 1 wherein said means for illuminating an area comprises a pair of light fixtures mounted on opposite end portions of said horizontal arm.

4. The portable telescoping light stand according to claim 3 wherein said pair of light fixtures are rotatably mounted on said horizontal arm.

5. The portable telescoping light stand according to claim 4 wherein said pair of light fixtures are rotatably mounted along an axis parallel to said horizontal arm.

6. The portable telescoping light stand according to claim 1 wherein said horizontal arm is selectively rotatably with respect said vertical conduit.

7. The portable telescoping light stand according to claim 3 wherein said pair of light fixtures each include a rectangular lens.

8. The portable telescoping light stand according to claim 1 wherein said vertical conduit has a plurality of pairs of holes aligned along its length, one of said pair of holes of said conduit being alignable with a pair of holes provided on a lower portion of said vertical extension to establish a predetermined height of said means for illuminating an area, said predetermined height being maintained by a pin being inserted into said one of said pairs of holes of said vertical conduit and said pair of holes of said vertical extension.
